(19) United States
(12) Patent Application Publication
(10) Pub. No.: US 2017/0343036 A1
(43) Pub. Date: Nov. 30, 2017

(54) DEVICE FOR PREVENTING COMPONENT FROM LOOSENING CAUSED BY REVERSE TRAVEL

(71) Applicant: Kai-Wei LIN, Huaian (CN)

(72) Inventors: Chen-Chiu CHU, Huaian (CN); Kai-Wei LIN, Huaian (CN)

(21) Appl. No.: 15/340,127

(22) Filed: Nov. 1, 2016

(30) Foreign Application Priority Data
May 25, 2016 (CN) 201620486555.6

(51) Int. Cl. F16B 39/22

(52) U.S. Cl. CPC F16B 39/22

(57) ABSTRACT

The present patent discloses a device for preventing components from loosening caused by reverse travel, comprising a shell and a cylindrical pin, wherein the cylindrical pin is clamped inside the shell, is in sliding connection with the shell and is capable of retracting into or extending out of the shell. Because of the presence of track positioning, the device disclosed by the present patent can ensure the positioning of the installed components just by performing positioning while fasteners are installed, can avoid the situation of reverse rotation or slip of the components and can be assembled without using any tool or spare parts kit. The device disclosed by the present patent is a hidden device which is automatically telescopic following actions, thereby being convenient to operate and not affecting the appearance.

### FIELD OF THE INVENTION

The present patent relates to the field of furniture assembly, in particular to a device for preventing components from loosening caused by reverse travel.

### BACKGROUND OF THE INVENTION

In the prior art, a furniture component may be rotatably installed with one screw, but it is only suitable for a circular component, and in case of encountering with a square component, it is possible to cause the square component not to be parallel to a corresponding component, thus leading to alignment failure, because of threads; it is likely to generate the situation of reverse rotation or slip of a component whatever the component is installed using screws or in a sliding way; it is necessary to additionally install other spare parts to secure for preventing the component from reversely rotating after the component is assembled, and therefore, it is also necessary to attach a spare parts kit and tool, and an operating space needs to be reserved for manual operation; and if the operating space is reserved inside, inconvenience in operation will be caused, and if the operating space is reserved outside, the beauty in appearance will be affected.

### SUMMARY OF THE INVENTION

The present patent aims to provide a device for preventing components from loosening caused by reverse travel, for a purpose of solving the problems proposed in the background art.

To realize said purpose, the present patent provides the following technical solution:

a device for preventing components from loosening caused by reverse travel comprises a shell and a cylindrical pin, wherein the cylindrical pin is clamped inside the shell and is in sliding connection with the shell.

As a further solution of the present patent, the cylindrical pin is capable of retracting into or extending out of the shell.

As a yet further solution of the present patent, the length of the cylindrical pin is greater than or equal to the depth of the shell.

As a yet further solution of the present patent, the shell is a circular shell.

Compared with the prior art, the present patent has the beneficial effects that: because of the presence of track positioning, the device disclosed by the present patent can ensure the positioning of the installed components just by performing positioning while fasteners are installed, can avoid the situation of reverse rotation or slip of the components and can be assembled without using any tool or spare parts kit. The device disclosed by the present patent is a hidden device which is automatically telescopic following actions, thereby being convenient to operate and not affecting the appearance.

### BRIEF DESCRIPTION OF THE DRAWINGS

FIG. 1 is a structural schematic drawing of the device for preventing components from loosening caused by reverse travel;

FIG. 2 is a contracted drawing when the device for preventing components from loosening caused by reverse travel is reversed;

FIG. 3 is an extended drawing when the device for preventing components from loosening caused by reverse travel is overturned;

FIG. 4 is a front view of a fixing fastener in embodiment 1;

FIG. 5 is a top view of a fixing fastener in embodiment 1;

FIG. 6 is a front view of a rotating fastener in embodiment 1;

FIG. 7 is a top view of a rotating fastener in embodiment 1;

FIG. 8 is a structural schematic drawing of a fixing fastener in embodiment 2;

FIG. 9 is a structural schematic drawing of a rotating fastener in embodiment 2;

FIG. 10 is a structural schematic drawing of a fixing fastener in embodiment 3; and

FIG. 11 is a structural schematic drawing of a sliding fastener in embodiment 3.

### DETAILED DESCRIPTION OF THE PREFERRED EMBODIMENTS

The technical solution in embodiments of the present patent will be described clearly and completely as below in conjunction with the drawings in embodiments of the present invention. It is obvious that the embodiments described are merely a part of embodiments of the present patent, rather than all of the embodiments. Based on the embodiments in the present patent, all the other embodiments made by common skilled in the art without paying creative work should be fall into the protection scope of the present patent.

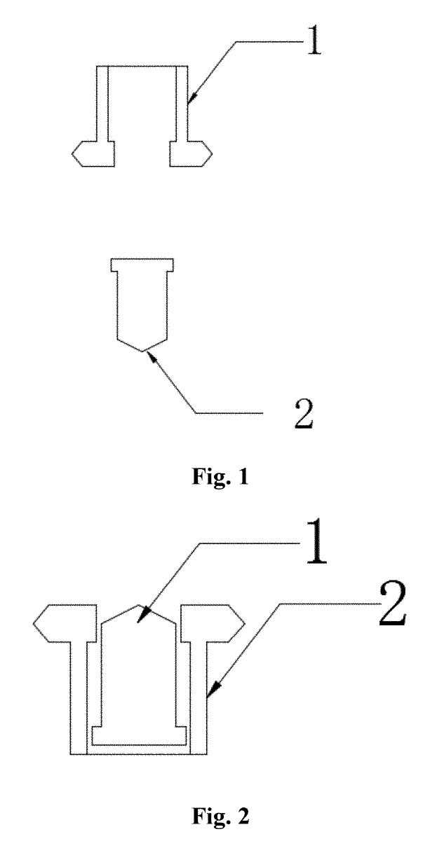

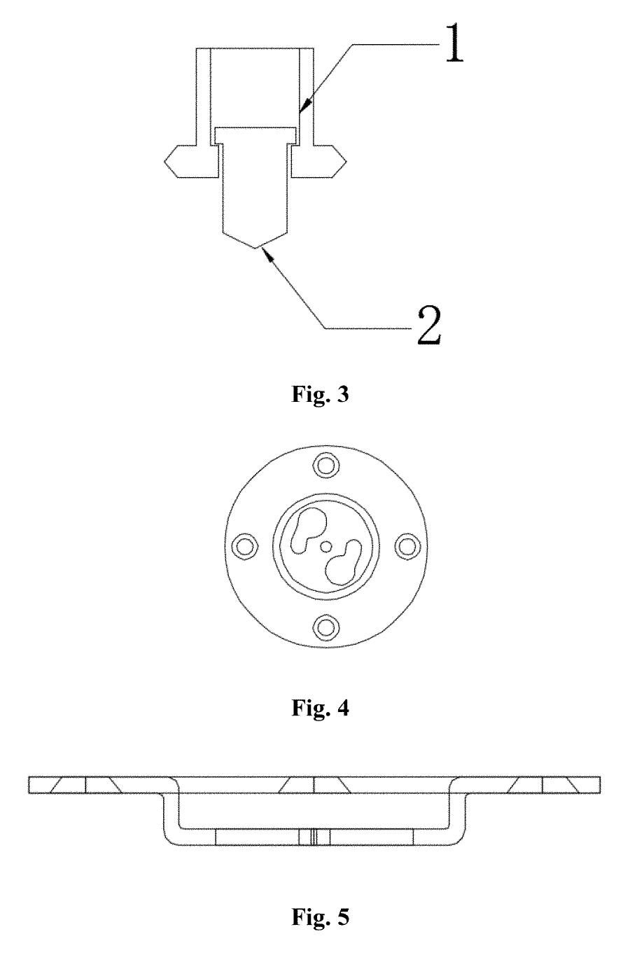

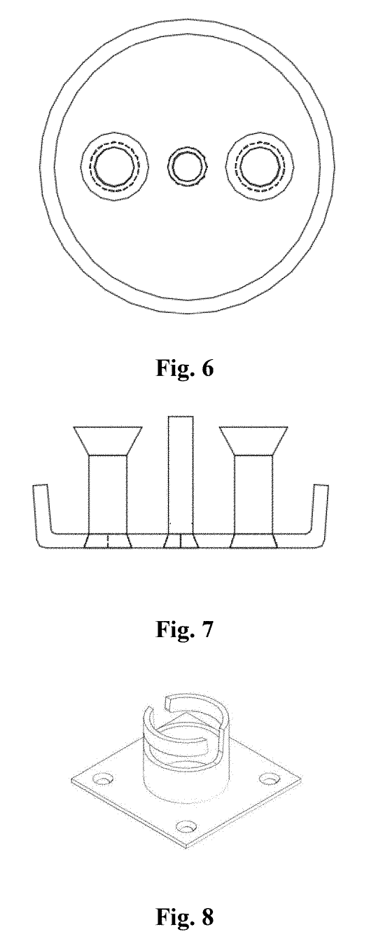

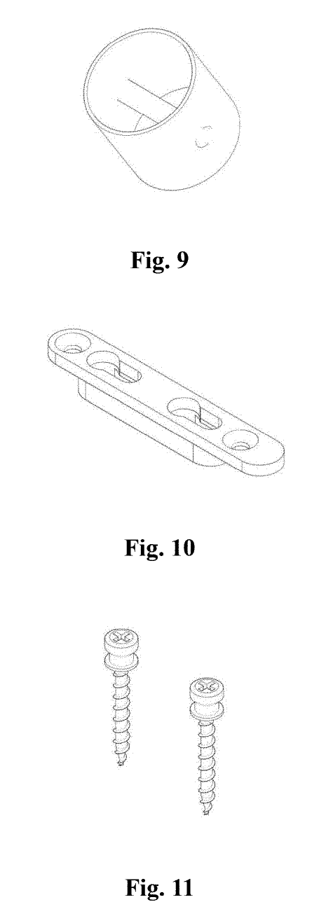

Referring to FIGS. 1-3, in an embodiment of the present invention, a device for preventing components from loosening caused by reverse travel comprises a shell 1 and a cylindrical pin 2, wherein the shell 1 is a circular shell, and the cylindrical pin 2 is clamped inside the shell 1 and is in sliding connection with the shell 1; the cylindrical pin 2 is capable of retracting into or extending out of the shell 1; and the length of the cylindrical pin 2 is greater than or equal to the depth of the shell 1. The device is a hidden device which does not affect the appearance and is unnecessary to be operated manually, and therefore, an automatically telescopic purpose is achieved when the components rotate forwards and backwards.

The present patent relates to a device for preventing two combined components from loosening, in an automatically dropping and contracting manner, when the components rotate forwards and backwards.

The present patent is applicable to all the combined components assembled in manners of rotating, sliding or the like. For example:

### Embodiment 1

A rotary assembly method I: the device comprises two components:

(1) a fixing fastener: the fixing fastener is a base made of a circular or square (or other shape) sheet iron (or other material) inside of which a space is reserved to adapt to a fastening component on a rotating fastener, said component being provided with a positioning hole and two tracks concentric with the positioning hole, wherein a track travel is a slope which enables the fasteners to be fastened gradually.

(2) The rotating fastener: the rotating fastener is a base made of a circular (or other shape) sheet iron (or other material) and is provided with a positioning pin and two fastening pillars.

### Embodiment 2

A rotary assembly method II: the device comprises two components:

(1) a fixing fastener: the fixing fastener consists of a base made of a circular (or other shape) sheet iron (or other material) and a pipe with tracks so as to adapt to a fastening component on a rotating fastener, wherein a track travel is a slope which enables the fasteners to be fastened gradually.

(2) The rotating fastener: the rotating fastener component is made of a circular (or other shape) pipe and is provided with a transverse pin.

### Embodiment 3

A sliding assembly method: the device comprises two components:

(1) a fixing fastener: the fixing fastener is a base made of strip-shaped plastic (or other material) and is provided with two (or other number) sliding tracks inside to adapt to a fastening component on a sliding fastener. The track travel is a slope which enables the fasteners to be fastened gradually.

(2) The sliding fastener: the sliding fastener is a circular (or other shape) cylindrical head made of plastic (or other material), and may be directly installed on an assembled object by threads or in a plugging-in manner.

An installation method of the device disclosed by the present patent comprises the following steps:

(1) installing the device on an assembled object first;

(2) installing the fixing fastener, the rotating fastener or the sliding fastener on components to be combined respectively;

(3) loading the component provided with the sliding fastener onto a corresponding component with the fixing fastener;

(4) rotating or sliding the movable component along tracks till being positioned; and

(5) after the movable component is installed, righting the assembled components, wherein a cylindrical pin 2 in a reversal prevention device automatically drops at this moment and is positioned at the front end of the fastening pillars, thus preventing table legs from reversing.

For those skilled in the art, it is obvious that the present patent is not limited to the details of the exemplary embodiments above, and can be realized in other specific manners on the premise of not departing from the spirit or essential characteristics of the present patent. Therefore, for every point, the embodiments should be regarded as being exemplary, not restrictive, and the scope of the present patent should be defined by the attached claims, rather than the above description, therefore all the variations falling into the meaning and scope of equivalent elements of claims are intended to be included in the present patent. Any reference symbols in claims should not be regarded to limit the related claims.

In addition, it should be understood that, this description made a description according to the implementations, but not each of all the implementations only includes an independent technical solution. Such narration form of the description is only for clarity, and those skilled in the art should take the description as an integer. The technical solutions in the embodiments may also be combined properly to form other implementations that may be understood by those skilled in the art.

What is claimed is:

1. A device for preventing components from loosening caused by reverse travel, comprising a shell (1) and a cylindrical pin (2), wherein the cylindrical pin (2) is clamped inside the shell (1) and is in sliding connection with the shell (1).

2. The device for preventing components from loosening caused by reverse travel according to claim 1, wherein the cylindrical pin (2) is capable of retracting into or extending out of the shell (1).

3. The device for preventing components from loosening caused by reverse travel according to claim 1, wherein the length of the cylindrical pin (2) is greater than or equal to the depth of the shell (1).

4. The device for preventing components from loosening caused by reverse travel according to claim 1, wherein the shell (1) is a circular shell.
